(19) United States
(12) Patent Application Publication
(10) Pub. No.: US 2013/0121435 A1
(43) Pub. Date: May 16, 2013

(54) Crosstalk Management For OFDM Communication System In Power Efficient Transmission Mode

(71) Applicant: METANOIA COMMUNICATIONS INC., Hsinchu (TW)

(72) Inventors: Chun-Che Chang, Hsinchu (TW); Ravi Mantri, Portland, WA (US)

(73) Assignee: METANOIA COMMUNICATIONS INC., Hsinchu (TW)

(21) Appl. No.: 13/677,215

(22) Filed: Nov. 14, 2012

Related U.S. Application Data
(60) Provisional application No. 61/559,173, filed on Nov. 14, 2011.

(51) Int. Cl. H04B 15/00

(52) U.S. Cl. CPC H04B 15/00
USPC 375/285

(57) ABSTRACT

In the present disclosure, several techniques are proposed to estimate the worst-case crosstalk noise and use it for bit-loading and SRA calculations so that fluctuating crosstalk when PET mode is enabled does not lead to system instability. One of the proposed techniques involves strategically placing some marker tones in the transmitters of the affecting lines. The noise floor may be inferred by interpolating the noise observed on these marker tones (tones that are always-on) and applying to the entire frequency band on the victim line. Another proposed technique involves periodically transmitting a set of marker symbols (fully loaded OFDM symbols), so that a victim channel can estimate the SNRs in a worst case crosstalk scenario.

### TECHNICAL FIELD

The present disclosure generally relates to the field of digital communication and, more particularly, to the management of crosstalk in orthogonal frequency-division multiplexing (OFDM)-based communication systems.

### BACKGROUND

In most OFDM-based communication systems (both wired and wireless), it is common for all communication channels to contribute a significant amount of crosstalk noise or interference to other neighboring communication channels. The crosstalk might be introduced by physically closely-placed channels (e.g., phone line wires) or by operation in a shared medium with imperfect crosstalk cancellation techniques. Data transmission over multiple-input-multiple-output-channels in wireless communications is one example and data transmission based on xDSL standards over phone line wires in a bundle is another example.

FIG. 1 shows a typical asymmetric digital subscriber line (ADSL)/very-high-bit-rate digital subscriber line (VDSL) communication system. A communication channel consists of a pair of twisted copper wire which is situated in a bundle and is surrounded by up to hundreds of pairs of other twisted copper wires. The length of the bundle ranges from a couple of feet to thousands of feet. As shown in FIG. 1, channel B is affected by the transmissions in channel A in the bundle. Accordingly, the term “victim channel” is used to refer to a channel that is affected by transmissions on other channels—as in the case of channel B in this example. The term “affecting channel” is used to refer to a channel that is affecting other channels—as in the case of channel A in this example. The terms “crosstalk” or “interference” are used herein to represent the leakage power experienced by the victim channel due to transmissions on the “affecting channel”.

Without a proper crosstalk cancellation technique, the contribution of crosstalk energy from the affecting line is treated as noise by the victim line. The crosstalk noise in some applications dominates the noise floor seen by the victim line. In order to maintain a stable noise floor without fluctuating crosstalk, these systems have to continuously transmit signals even when there is no payload or user data to transmit. The reason to continuously transmit signals is to ensure that the crosstalk in neighboring channels is steady and the signal-to-noise ratio (SNR) measurements are not affected by varying crosstalk noise, resulting in steady SNR margin and operation without frequent receiver errors or connection drops due to excessive errors in the received data. This was an acceptable technique for several years. However, in recent years, “power savings” and “green operation” have become important design and implementation considerations. To address the power saving requirement in existing always-on communication systems like ADSL and VDSL, it is natural to consider switching off the transmitter when there is no payload data to transmit. As can be seen from FIG. 1, by switching the transmitter on and off rapidly in one channel, the crosstalk noise as experienced by neighboring communications channels is consequently affected, thereby affecting the measured SNR and bit-loading in the neighboring channels. This has become a primary issue in applying power saving techniques that switch off the transmitter when there is no data traffic.

### SUMMARY

In a crosstalk-affected OFDM communications system, a transmitter enters into a “power saving mode”, or power efficient transmission (PET) mode, when there is no payload data to transmit. The transmitter enters into the PET mode by switching off tones that are allocated to carry payload data or periodically switching off the transmitter completely. To aid crosstalk noise estimation on other victim channels, a small number of strategically-placed tones may be transmitted in the transmitter of the affecting line consistently or periodically. These strategically-placed tones are referred to as “marker tones” or “markers”. Depending on the requirement of the application, marker tones can be mapped to fixed constellations or can carry control data or payload data. Marker tones can be at fixed frequencies or vary in frequencies during different OFDM symbols in time following a pre-defined pattern. Alternatively or additionally, a similar approach may be applied to the transmitter of an affecting line by transmitting a small number of strategically-placed fully loaded OFDM symbols periodically in PET operation. These symbols are referred to as “marker symbols”. Estimation of noise power for the victim channel can thus be done by observing these marker tones or marker symbols in a receiver and inferring a noise floor by interpolation between consecutive markers tones or marker symbols.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure.

FIG. 1 illustrates a symbol-aligned very-high-bit-rate digital subscriber line 2 (VDSL2) communication system.

FIG. 2 illustrates the signal-to-noise ratio (SNR) in a victim line when an affecting line is idle (not transmitting any payload data).

FIG. 3 illustrates the SNR in a victim line when an affecting line is transmitting payload data.

FIG. 4 illustrates noise estimation uring marker tones in accordance with an embodiment of the present disclosure.

FIG. 5 illustrates a VDSL system with asynchronous clock at central office side.

FIG. 6 illustrates power leakage versus symbol alignment offset in accordance with an embodiment of the present disclosure.

### DETAILED DESCRIPTION OF PREFERRED EMBODIMENTS

### Overview

In a crosstalk-affected OFDM communications system, instead of turning off a transmitter completely for power saving, the transmitter enters into a “power saving mode”, or power efficient transmission (PET) mode, when there is no payload data to transmit. The transmitter enters into the power efficient transmission mode by switching off most of the tones that are allocated to carry payload data while leaving a small number of strategically-placed tones or some of the OFDM symbols on. These always-on tones or OFDM symbols are referred to as “marker tones” or “markers”. Depending on the requirement of the application, marker tones can be mapped to fixed constellations or can carry control data or some amount of payload data. Estimation of noise power for a victim channel can thus be done by observing these marker tones in a receiver and inferring a noise floor by interpolation between consecutive markers in some cases.

The marker tones can either be mapped to a fixed set of tones during one or more OFDM symbols or, alternatively, they can be mapped to different tones during different OFDM symbols. In some cases the complete OFDM symbols are designated as marker symbols. As long as the victim channel is aware of the pattern used to map the marker tones or marker symbols, the pattern can be utilized to estimate SNR when the crosstalk from neighboring “affecting channels” is at maximum.

The proposed PET technique can achieve a significant amount of power reduction in an OFDM communication system such as ADSL or VDSL. However, the dynamic crosstalk behavior introduced by PET differs from the traditional xDSL crosstalk model and may render system-wide stability an issue.

Under PET mode, tones that are assigned to carry payload data traffic are muted when there is no payload data to send and makes the crosstalk behavior traffic-dependent. A victim line sees highly unpredictable and time-varying crosstalk from adjacent lines. The training time during which SNR measurement is done in a victim line is critical because the bit-loading is based on the measured SNR. If there is unpredictable or time-varying crosstalk from adjacent lines during this time the resulting bit-loading cannot be applied reliably. If the bit-loading is done when there is no traffic in the affecting lines, it may be higher than what it should be and it may result in instability in the victim line. Further, wide variation in crosstalk noise makes it impossible for the SRA (Seamless Rate Adaptation) as defined in ITU-T G993.2 to work properly because the SNR is dynamically changing.

In the present disclosure, several techniques are proposed to estimate the worst-case crosstalk noise and use it for bit-loading and SRA calculations so that fluctuating crosstalk when PET mode is enabled does not lead to system instability. One of the proposed techniques involves strategically placing some marker tones in the transmitters of the affecting lines. The noise floor may be inferred by interpolating the noise observed on these marker tones (tones that are always-on) and applying to the entire frequency band on the victim line. Another proposed technique involves periodically transmitting a set of marker symbols (fully loaded OFDM symbols), so that a victim channel can estimate the SNRs in a worst case crosstalk scenario.

The basic idea is similar in principle to virtual noise where noise floor is described by a power spectral density (PSD) descriptor as defined in ITU-T G.993.2. By strategically placing some marker tones or marker symbols in the transmitters of the affecting lines, the noise floor may be inferred by interpolating the noise observed on these marker tones or marker symbols and applying to the victim line. The interpolated noise can be stored internally and thus be used for bit-loading or SRA. To simplify the implementation, one possible way of choosing marker tones includes using evenly-distributed tones.

An additional technique uses fully loaded OFDM symbols (marker symbols) sent occasionally to allow victim lines to estimate the SNRs accurately under the worst case crosstalk scenario. This technique can be used on its own or, alternatively, it can also be combined with the techniques that use marker tones to improve the SNR measurement accuracy and stability of connections when PET is enabled on those lines. For example, some of the OFDM symbols may use marker tones and some of the OFDM symbols may be designated as marker symbols. The SNRs may be measured on marker symbols and fine-tuned using the marker tones.

### Example Implementation

### Symbol-Aligned Channels

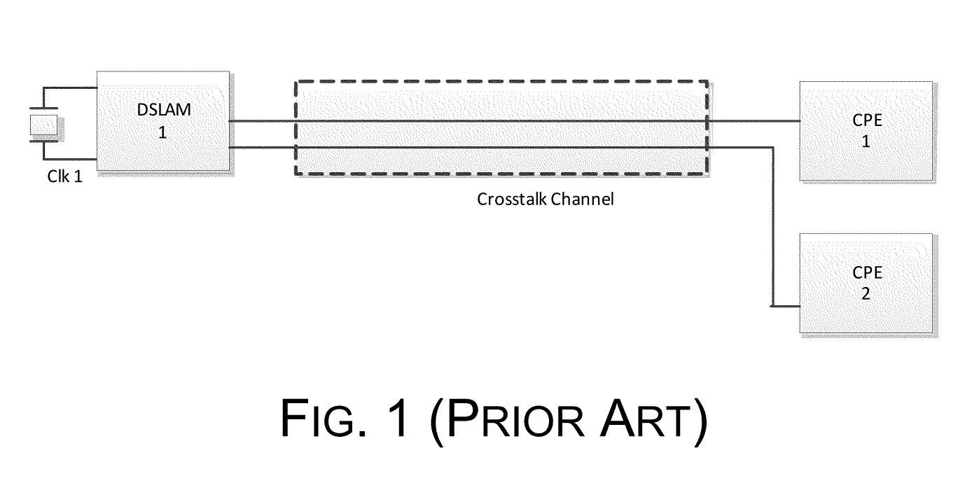

Symbol-aligned channels are the communication channels resulting from synchronous transmission of OFDM symbols on all these channels. The symbol boundaries across all channels are very close to each other (within an error of a few micro seconds for a typical VDSL system running ITU-T G.993.5) and hence orthogonality across all channels is maintained. As an example, a typical symbol-aligned VDSL2 system is depicted in FIG. 1. Client premises equipment (CPE) 1 and CPE 2 are connected to a same DSLAM, and clocks and symbol boundaries are maintained across CPE 1 and CPE 2. Under this configuration, a receiver can estimate crosstalk energy on the marker tones or marker symbols without any difficulty.

### 1. Marker Tones Method

In order to ensure a reliable bit-loading calculation, the worst-case crosstalk estimation where all active lines in a bundle are transmitting at full power is to be assumed. By allocating marker tones in the transmitter of the affecting line, the worst-case estimation is possible by the receiver of the victim line by observing the energy on the marker tones and inferring a crosstalk PSD by interpolation. A marker tone can use a fixed constellation, modulated by a known pattern or modulated by data traffic. The tone indexes for markers are known a-priori and 4 QAM (4-point constellation) may be used on these tones to ensure an accurate estimation. The idea is illustrated in the following figures where one affecting line is assumed:

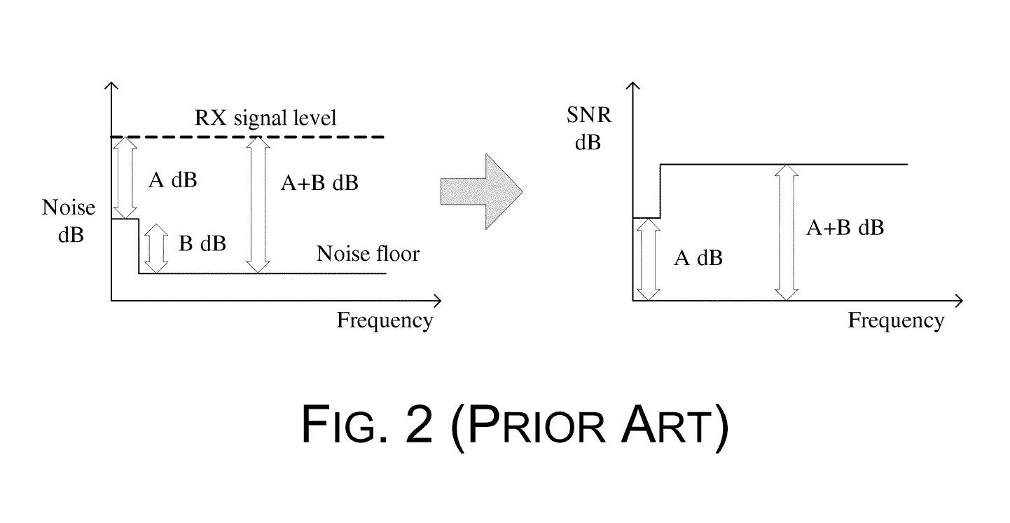

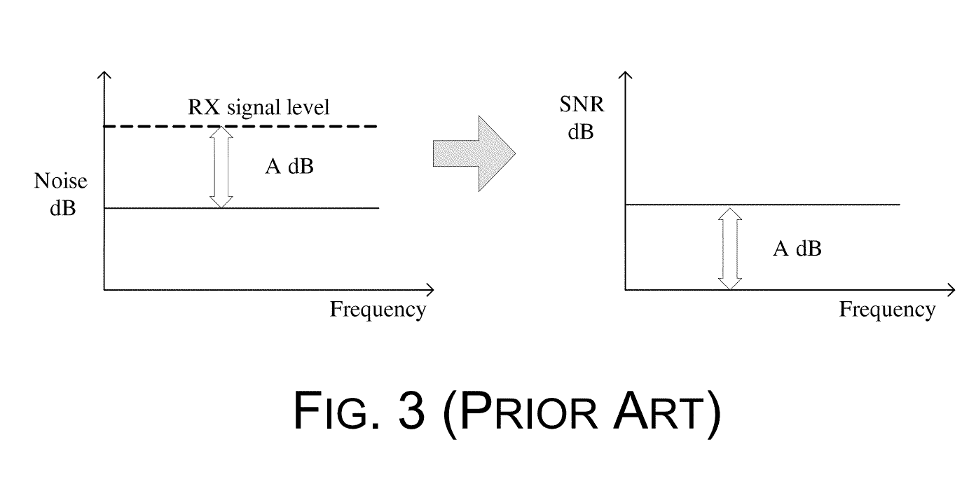

FIG. 2 represents the SNR in a victim line when the affecting line is not transmitting any payload data. The SNR observed by the victim line is high (A+B dB) except in the low frequency region (A dB) where some management overhead data is modulated. In the higher frequency region, the SNR is high (A+B dB) because there is no transmission in that region in the affecting line. The overall SNR is unrealistically high due to no crosstalk in the tones allocated for payload data and will drop to the SNR in FIG. 3 abruptly as soon as payload data is transmitted in the affecting line.

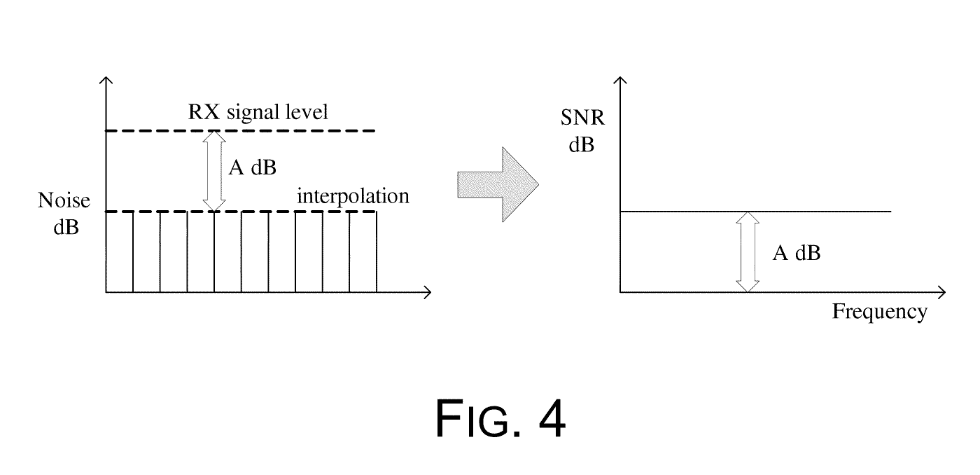

To make the connection robust and to maintain SNR margin, using SNR of FIG. 3 (flat A dB) for bit-loading calculation is desirable. However, there is no guarantee that there will be payload traffic in the affecting line generating crosstalk in the victim line, when the victim line is doing SNR and bit-loading calculation. This problem is solved by modulating some tones in the affecting line evenly in the spectrum and deriving a pseudo noise floor in the victim line by interpolating SNR or noise observed on these tones and applying to the whole band. Alternatively, some or all tones in the marker set are modulated by 4 QAM in the affecting line to carry management data instead of dedicating those lines for sending a known pattern. Although this is not necessary, it can lead to better utilization of channel capacity. This idea is illustrated in FIG. 4.

### 2. Marker Symbols Method

Instead of using marker tones, periodically transmitting fully loaded OFDM symbols (marker symbols) can be done so that a victim channel can estimate the SNRs in a worst case crosstalk scenario. If all the lines in the bundle transmit fully loaded OFDM symbols during the same OFDM symbol with the same frequency (e.g., once every 256 symbols, 16 times every 1024 symbols etc.), the SNRs estimated during those symbols may lead to more reliable bit-loading and stable connections. A fully loaded OFDM symbol represents a symbol in which all the active tones (those with bit-loading >=1) are fully loaded with payload data, management data or a known pattern. In other words, those symbols have no muted tones. One straight-forward choice of marker symbols for an ITU-T G.993.5 VDSL system is the SYNC symbols. As specified in ITU-T G.993.5, a SYNC symbol is transmitted every 257 OFDM symbols and is modulated by 4-QAM constellations.

### Example Implementation

### Symbol-Unaligned Channels

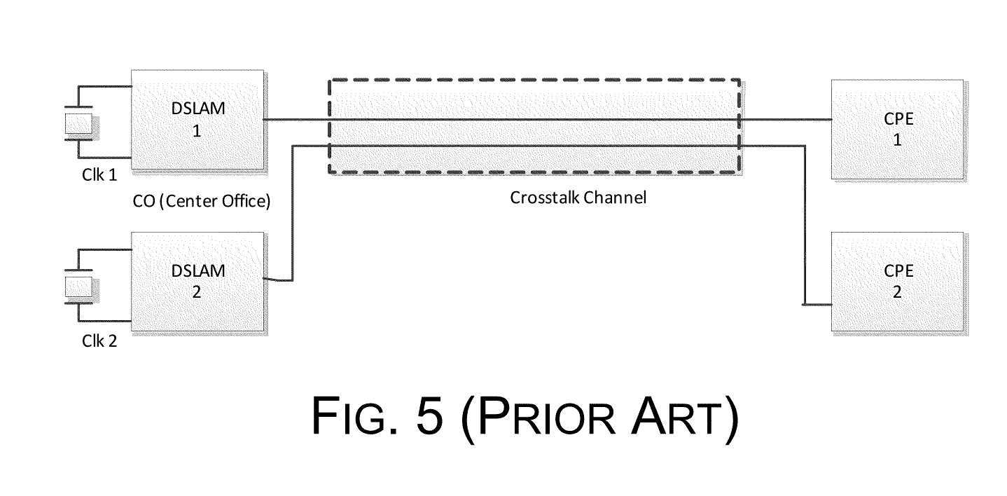

In this case symbols across all communication channels are not aligned and synchronized in time. An example is the ITU-T G.993.2 VDSL2 system as depicted in FIG. 5 where the copper communication channels in the same bundle are fed by different DSLAMs (Digital Subscriber Line Access Multiplexers), each running on its own clock. Since clock or symbol boundary is not aligned in this case, some modification to the techniques using marker tones or marker symbols is needed.

### 1. Marker Tones Method

For a modem operating in an unaligned environment, if this modem is PET aware, it is expected to estimate noise on the marker tones and derive a worst case noise PSD for bit-loading as in the symbol-aligned case. However, a problem arises due to the fact that symbol boundary in each loop may not be aligned. We have found that due to the misaligned symbol boundaries, the accuracy of estimated noise on the marker could vary by more than 10 dB and render the above method useless without any modifications.

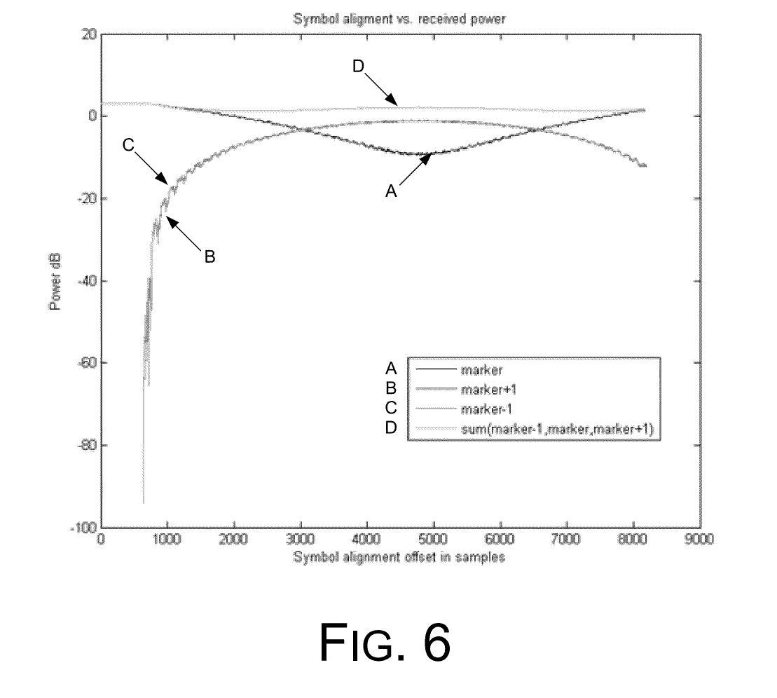

During simulation by the inventors, the worst-case scenario is used to investigate this problem. The affecting line is transmitting marker tones at multiples of bin 64. The constellation for the first symbol for each marker tone comes from a random sequence. The constellation for the second symbol is a 180 degree phase reversal of the first symbol. An IFFT size of 8192, a CE of 640 and a beta window of 128 points is used. The simulation walks through all possible alignment and the observed spectrum by the victim line is shown in FIG. 6.

As can be seen in FIG. 6, as the receiver alignment goes beyond the protection offered by the cyclic extension, the energy from the affecting line leaks into adjacent tones. Assuming that markers described below are implemented in an unaligned bundle (unbundled) environment, a victim line sees a spread spectrum of the markers from the affecting lines. We provide three possible solutions to this problem as described below.

### A. Energy Concentration Method

As the simulation result in FIG. 6 shows, the spread energy of a tone N observed by the victim line is concentrated at tones N−1, N and N+1. With this result in mind, when a victim line performs crosstalk estimation, it sums energies on these three tones and uses the total energy as the noise energy for the specific marker. This method, however, tends to give a more conservative bit-loading, which may lead to somewhat reduced data rates.

### B. Pilot Method

In G.993.2 standard, up to 16 pilots are allowed in the downstream direction. If we select these pilot tones carefully so that each of them is continuous across the symbol boundary with cyclic extension, then theoretically there is no spread energy on these tones and a reliable crosstalk estimation can be made on these tones. The tones that are continuous over symbol boundaries follow the formula below:

N=SymbolLen/(gcd(SymbolLen,CeLen))*ki,ki=1,2,3, etc

For a typical VDSL2 system where SymbolLen=8192 and CeLen=640, N=64*ki. This method would give the best estimation of the crosstalk energies on the marker tones. Note this method requires the marker tones stay at the same phase every symbol hence they cannot be used for data transmission.

### C. Time of Day (ToD) Method

ToD (Time of Day) is a technique used to distribute clock (date, hour, minutes, seconds) in a communication system. A typical ToD clock accuracy for a VDSL system is 3-5 uS. If ToD is implemented in the communication system, it is possible to achieve symbol alignment across all lines with little effort. This case then reduces to aligned scenario and the techniques described earlier for symbol aligned case can then be applied as well. Note that any alternative method that synchronizes the transmission times on different channels enables using the techniques described earlier for the symbol aligned case.

### 2. Marker Symbols Method

The idea of using marker symbols, i.e., periodically transmitting a set of fully loaded OFDM symbols, is the same as described in the symbol-aligned scenario. However, in case of unaligned channels, if the SNR estimation is done leaving enough guard interval (e.g., using middle 16 OFDM symbols among the 32 consecutive OFDM symbols that are fully loaded), it would represent the SNRs during worst case crosstalk and lead to reliable connections with equalized SNR margins. Alternatively, if the modems support ToD then they can use that to transmit fully loaded OFDM symbols at the same time, to allow accurate crosstalk estimation and SNR measurement. Note that any alternative method that synchronizes the transmission times on different lines in the bundle enables using the techniques described earlier for the symbol aligned case.

### CONCLUSION

By carefully choosing marker tones and marker symbols and making the communication system PET-aware, the bursty crosstalk PSD issue of PET can be solved completely. A small amount of complexity introduced by implementing PET and PET-aware techniques, can lead to generous rewards in terms of power-saving.

Although select embodiments are described above, they are not intended to limit the scope of the present disclosure. It will be apparent to those skilled in the art that various modifications and variations can be made to the disclosed embodiments of the present disclosure without departing from the scope or spirit of the present disclosure. In view of the foregoing, the scope of the present disclosure shall be defined by the following claims and their equivalents.

What is claimed is:

1. A method comprising:
generating a noise in a first digital data transmission medium at a first level equivalent to a highest level expected in the first digital data transmission medium;
repeatedly generating the noise at the first level in the first digital data transmission medium at a predetermined interval for a plurality of times;
determining a plurality of noise levels observed in a second digital data transmission medium that is adjacent to the first digital data transmission medium at the predetermined interval; and
interpolating a noise floor level in the second digital data transmission medium using the observed noise levels.

2. The method of claim 1, further comprising:
based on the interpolated noise floor level, determining a first signal-to-noise ratio (SNR) or signal-to-interference ratio (SIR) for transmitting data over the second digital data transmission medium; and
transmitting data over the second digital data transmission medium based on the first SNR/SIR.
